(19) United States
(12) Patent Application Publication
(10) Pub. No.: US 2004/0028050 A1
(43) Pub. Date: Feb. 12, 2004

(54) Communications system

(76) Inventor: Richard J. Proctor, Dorset (GB)

Correspondence Address: Kirschstein Ottinger Israel & Schiffmiller, 489 Fifth Avenue, New York, NY, 10017-6105, US

(21) Appl. No.: 10/333,836

(22) PCT Filed: Jul. 19, 2001
(86) PCT No.: PCT/GB01/03267

(30) Foreign Application Priority Data
Jul. 25, 2000 (GB) 0018092.7

(51) Int. Cl. H04L 12/56

(52) U.S. Cl. 370/395.1

(57) ABSTRACT

A partitioned switch comprising a plurality of switch partitions in which at least some of the partitions comprise one or more physical ports, in which the partitioned switch comprises means for establishing a connection for communication of data between a first physical port on a first partition and a second physical port on a second partition; in which the connection is effected completely internal to the switch. The communication between the physical ports is established by means of a series of consecutive virtual connections through the switch. The partitioned switch also comprises means for monitoring data input at the first physical port for transport via the physical connection to the second physical port and generating statistics relating to the equivalent data traffic associated with one or more of the virtual ports used to set up the physical connection.

The present invention relates to the field of communications systems in general and to the field of partitioned switches in particular.

A Control Switch Interface (CSI) is currently being developed by the Multiservice Switching Forum (MSF) to define an interface between switch controllers and switches.

The CSI allows for switch partitioning. A partitioned switch one that is divided into a number of smaller, independently controlled partitions or “switchlets” for use by different services or different operators. For example, a partitioned switch may be divided between an IP switching network, an ATM network and a Frame Relay Network. A switch could also be divided up so that different parts of the same switch are available to different operators: the switch being owned by one operator or network equipment provider, who sublets parts of the switch to other operators.

The current switch partitioning concept does not allow for the direct interconnection of partitions. Although this may not be important for switches divided on a service basis, there may be a need for a switch that is partitioned between a number of operators to provide interconnection between these operators.

One conventional way of connecting individual partitions of a switch is by physical links, which are made by cables connected externally to the switch. This is expensive, inflexible and adds unnecessary cost and transmission delay.

The present invention provides a partitioned switch comprising a plurality of switch partitions and a plurality of switch controllers, each controller for setting up a connection through a different one of the partitions; in which first and second ones of the partitions each comprise one or more physical ports, in which the switch also comprises association means for establishing associations between partitions for setting up a virtual link between a first physical port on the first partition and a second physical port on the second partition and connection means for setting up a physical connection between the physical ports so linked.

The present invention further provides a method for setting up a physical connection through a partitioned switch between a first physical port from a first partition and a second physical port from a second partition, the method comprising the steps of setting up a first virtual connection through the first partition between the first physical port and a first virtual port and a second virtual connection through the second partition between the second physical port and a second virtual port forming a series of viral connections linking the first and second physical ports by setting up an association between the partitions, and setting up a physical connection between the physical ports so linked.

The present invention further provides a method of setting up a physical connection through a partitioned switch including the steps of setting up virtual connections through a plurality of partitions, setting up an association between a first one of the plurality of partitions and a second one of the plurality of partitions and using the association to set up a physical connection between a first physical port on the first partition and a second physical port on the second partition, in which the virtual connections use a plurality of virtual pots and only the first and second physical ports.

Embodiments of the present invention will now be described by way of example with reference to the drawings in which:

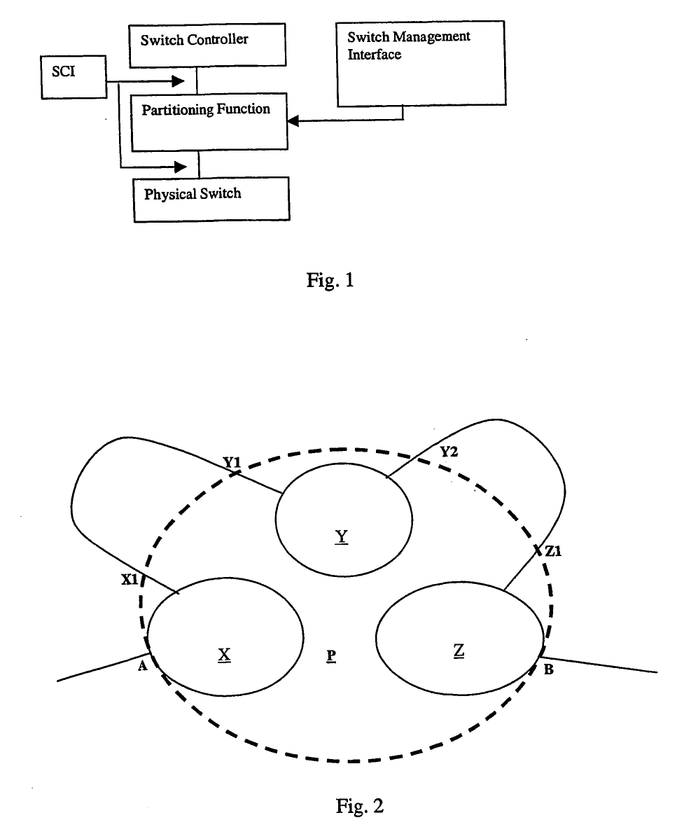

FIG. 1 shows a conventional management organisation for a partitioned switch;

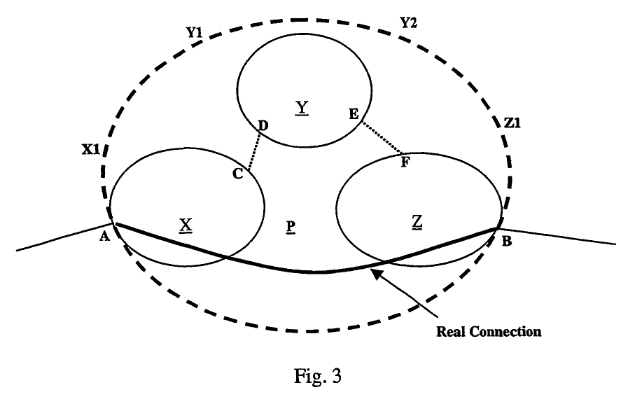

FIG. 2 shows a conventional partitioned switch;

FIG. 3 shows a partitioned switch according to the present invention.

FIG. 1 illustrates the relationship between switch controller(s), a partitioning function and the physical switch. There can be many switch controllers, one for each partition. The switch controller is the application running the service for an operator on a switch partition. The Switch Partitioning Function (SPF) maps switch requests from each switch controller for each partition on the real switch. The partitioning is established over the Switch Management Interface (SMI). The interfaces (SCI) between each switch controller and the SPF, and between the SPF and the switch are identical, so the SPF can be omitted in a non-partitioned system.

FIG. 2 shows physical switch ‘P’ which is divided up into a plurality of partitions or ‘switchlets’ X, Y and Z. The physical switch ‘P’ has a number of conventional physical ports A, X1, Y1, Y2, Z1 and B with port A being in partition ‘X’ and port B being in partition ‘Z’.

FIG. 2 also illustrates the problem with conventional switches more clearly. By way of example, in order to connect A and B using conventional, external connections would require:

A physical internal switch connection from Port A to port X1 through partition X;

A physical external link from Port X1 to Port Y1;

A physical internal switch connection from Port Y1 to Port Y2 through partition Y;

A physical external link from Port Y2 to Port Z1;

A physical internal switch connection from Port Z1 to Port B through partition Z.

FIG. 3 shows physical switch ‘P’ according to a first embodiment of the present invention in which the connection between ports A and B on the switch P may be achieved without external connections X1-Y1 and Y2-Z1. According to the present invention, as illustrated by FIG. 3, this connection is set up on the basis of a plurality of consecutive virtual connections established through the switch partitions X, Y and Z. A virtual connection is one on the switch where one or both end points is a virtual port, e.g. the connection from D to E in FIG. 3. The applications controlling each switch partition need not be aware that some connections are physical and some are virtual. Each application or switch controller makes its own connections between physical ports and/or virtual ports without having to know that there are virtual ports.

A virtual port is a port on a switch partition that has no physical realisation for the transport of data but will typically be a purely software function implemented in the SPF. Each virtual port maps to one (or more) other virtual port located on one (or more) other partition, i.e. an association is established between two switch partitions under control of the SPF by means of virtual ports.

It is desirable to interconnect the partitions within the physical switch in such a way that, as far as switch controllers are concerned, each is in control of a separate physical switch (i.e. a separate node of a communications network) with physical ports, even though one (or both) ends of a path through the partition under their control may be on a virtual port that is mapped to another virtual port on another partition.

When a connection is signalled to the switch controller for a node (partition), the switch controller routes the connection to another node in the network (which in this case happens to be on the same physical switch on another partition), it selects a port to send the connection to and signals to the next node in the network about the connection. The next node then picks up the connection and routes it across itself and so on using standard signalling as in any telecommunications or connection orientated data network. When these two nodes actually consist of two partitions on the same physical switch, the signalling between the associated switch controllers may be achieved in a conventional way using SS7 but now referring to the virtual port(s) that map between the two partitions as if they were conventional, physical ports. Data communication is however between the real physical ports that actually carry the data.

When a message is received at a physical port on a switch partition, the switch controller for that partition will make use of the SPF to establish a connection through the partition under its control from the physical port to a physical port or a virtual port without being aware that it is a virtual port. This process is continued in further switch partitions until the desired second physical port is reached so that a series of consecutive virtual connections through the physical switch has been established between two physical ports. Once the series of virtual connections is established from the input physical port A to the destination physical port B the switch partitioning function (SPF) sets up a “real” data link through the switch directly from the input physical port to the destination physical port.

When two connections are made from different physical ports using the same circuit on a virtual port on one switch partition and its mapped virtual port on another switch partition, the data associated with the connections is brought together, and treated as one connection.

Referring by way of example to the situation of FIG. 3, a connection is being routed from physical port A on partition X to physical port B on partition Z. There are no direct connections between partitions X and Z, but both are interconnected to partition Y. The steps needed to set up the virtual connections from physical port A to physical port B, in the example as illustrated in FIG. 3, are as follows:

An incoming call is detected by the switch controller for partition X. The SPF is requested to set up a virtual connection from physical port to A to virtual port C through partition X under the command of the switch controller for Partition X;

The SPF maps the virtual port C to associated virtual port D, and waits as the connection only has one physical port;

The switch controller for X signals (e.g. via an SS7 link) to the switch controller for adjacent partition Y to accept the call

The SPF is requested to set up a virtual connection from virtual port D to virtual port E through partition Y under the command of the switch controller for Partition Y;

The switch controller for Y signals (e.g. via an SS7 link) to the switch controller for adjacent partition Z to accept the call

The SPF maps virtual port E to associated virtual port F, the data for the connection now links physical port A to virtual port E (through C and D). The SPF waits as the connection still only has one physical port;;

The SPF is requested to set up a virtual connection through partition Z from virtual port F to physical port B under the command of the switch controller for partition Z;

The SPF now has a series of consecutive virtual connections from A to B (through C, D, E and F) with both A and B being physical ports. The SPF then establishes the real connection between ports A and B on the physical switch P with a conection request.

The switch controllers do not need to be aware of the physical connections between the physical ports as this is set up and controlled by the SPF. Switch controllers are only concerned with the (virtual) connections within their own switch partition.

In the example above, virtual port C on switch partition X might be numbered port 17, on that partition but associated virtual port D might be numbered port 5 on switch partition Y.

When a connection is cleared by one application, the SPF removes the physical connection on the switch. In the example it would remove the real connection A to B. The other data about the connection is retained, including all mappings along the path. This allows for an application to change a connection, for example to divert the connection, or to route it another way.

The rules for the presence of the real connection are:

If there is a complete mapping from one physical port to another physical port the connection should be setup.

If the mapping is incomplete in one or more partitions, then there should be no connection setup on the switch.

Point to Multi-point and Multi-point to Point connections are treated in the same way for each separate leg of connection. If the leg is complete it is established on the switch, if incomplete it is not.

A virtual port in a switch partition controlled by a first operator (i.e. by means of a switch controller) that maps to a virtual port in a switch partition controlled by a different operator may need to be policed, have statistics generated and have other management features normally associated with physical ports. According to a further embodiment of the present invention these issues may be addressed as follows.

Physical ports may be set up to carry data traffic associated with different channels/circuits. Existing counters at physical ports may be used to provide information on all data associated with a particular virtual connection, or alternatively a part (e.g. one channel) of the data associated with that virtual connection.

According to a further preferred embodiment the SPF may be used to collect data on the traffic passing through the physical ports and then generate the necessary statistics within the switch about the virtual ports. This is done without affecting the physical ports. We now describe converting such physical port measurements to virtual port statistics.

Taking the previous example, as illustrated in FIG. 3 further, the connection may be policed and counted at physical ports A and/or B: any usage property of the connection that needs to be assessed at a virtual port must be measured at the related physical ports. If traffic measurements of individual connections are wanted; for example the traffic arriving at port D on Partition Y above, then the SPF would ensure that the necessary data is counted at port A. The count for the traffic arriving at A is then used when the traffic count of port D is requested or generated. In a more elaborate example where the system wants aggregate traffic counts at port D, then all the calls through D would be counted at source (i.e. at respective physical ports) and the SPF then adds the counts for each of those connections to generate the aggregate count.

Each virtual port may be associated with more than one virtual connection, with each virtual connection originating at a different physical port. Aggregate measurements for the traffic that is sent from one partition to another are provided by the SPF aggregating the counts at the relevant physical ports for each individual connection that uses the virtual port.

Limitation of the effective bandwidth of a virtual port can be applied when performing the Connection Acceptance Check (CAC) in the switch controller application (i.e. a check to ensure that the switch has sufficient capacity to carry a specified amount of data), the system relying on the policing of the physical input port or ports.

The conventional signalling between applications controlling different partitions is unaffected by the fact that they are on the same switch and does not have to change. The applications behave as if they where on separate nodes and signal between them in exactly the same way they would as separate nodes At the lowest layers of the network signalling protocols there may be shortcuts between switch controller applications (e.g. at MTP layer 2 or 3 for SS7 signalling), although these are not essential.

Virtual ports on switch partitions will need to be established in different ways to the physical ports. The switch controllers for the partitions view virtual ports as normal physical ports, but the SPF will be configured with details of mappings between associated virtual ports. The SPF, under the control of the SMI handles all aspects of the virtual ports and virtual connections. Neither the applications, nor the physical switch(es) need be aware of the existence of the virtual ports.

Terminology

GSMP General Switch Management Protocol—Generated by the IETF (see IETF RFCs 1953, 1987, 2297).

MSF Multiservice Switching Forum

MITP Message Transmission Part (of SS7)

SCI Switch Control Interface—a MSF term for the interfaces between a switch and a controller. GSMP version 3 is the chosen protocol. There are two interfaces supported by the MSF that use the SCI; one is between the controller and the switch partitioning function, and one between the switch partitioning function and the switch(es).

SMI Switch Management Interface—a MSF term for the management interface to control the partitioning of a switch. This is broken down into a number of special cases by the MSF, but the term SMI is used here for the generic management of switches, independent of which particular part of the system it represents.

SPF Switch Partitioning Function.

SS7 Signalling System Number 7 (as defined in ITU-T specifications Q.700 to Q.849).

1. A partitioned switch comprising a plurality of switch partitions, in which the partitioned switch comprises association means for establishing an association between a first partition and a second partition; in which the means comprises a virtual port in each of the first and second partitions for establishing communications therebetween.

2. The partitioned switch as claimed in claim 1 in which the association means comprises a series of consecutive virtual connections through the first partition and the second partition.

3. The partitioned switch as claimed in any one of claims 1 and 2 in which the first and second partitions each comprise one or more physical ports, in which the association means comprises connection means for establishing a connection for communication of data between a first physical port on the first partition and a second physical port on the second partition; in which the connection is effected completely internal to the switch.

4. The partitioned switch as claimed in any one of claims 1 and 2 in which the first and second partitions each comprise one or more physical ports, in which the association means comprises connection means for establishing a connection for communication of data between a first physical port on the first partition and a second physical port on the second partition; in which the data on the connection between the first and the second physical ports flows only through the switch.

5. The partitioned switch as claimed in any one of claims 3 and 4 in which the connection means comprises the virtual ports.

6. The partitioned switch as claimed in any one of claims 3 to 5 as dependent from claim 2 in which the connection means comprises the virtual connections.

7. The partitioned switch as claimed in any above claim in which the association means comprises means for setting up a series of consecutive virtual connections through the switch between the first and the second physical ports for establishing a path for the communication of data therebetween.

8. The partitioned switch as claimed in any above claim as dependent from claim 2 in which the series of consecutive virtual connections comprises a virtual connection in each of one or more further partitions.

9. The partitioned switch as claimed in any one of claims 3 to 8 comprising means for monitoring data input at the first physical port for transport via the physical connection to the second physical port and generating statistics relating to the equivalent data traffic associated with one or more of the virtual ports used to set up the physical connection.

10. A method for establishing an association between a plurality of switch partitions on a partitioned switch, the method including the steps of setting up one or more virtual ports in each of a first and a second partition for establishing communications therebetween.

11. A method for establishing a path within a partitioned switch for the communication of data between a first physical port on a first partition and a second physical port on a second partition on the partitioned switch; in which the partitioned switch comprises a plurality of switch partitions in which at least some of the partitions comprise one or more physical ports; the method including the steps of setting up a first virtual port in the first partition and a second virtual port in the second partition for establishing communications therebetween.

12. The method of claim 11 including the steps of establishing a first virtual connection in the first switch partition between the first physical port and the first virtual port; establishing a second virtual connection in the second switch partition between the second virtual port and the second physical port and establishing such further virtual connections between virtual ports on further switch partitions as are necessary in order to provide a series of sequential virtual connections from the first physical port to the second physical port.

13. The method of claim any one of claims 11 and 12 also including the steps of monitoring data input at the first physical port for transport via the switch to the second physical port and generating statistics relating to the equivalent data traffic associated with one or more of the virtual ports used to set up the physical connection.

14. The method of claim 13 in which the first physical port supports a plurality of channels, each channel for carrying different data traffic; the method including the steps of monitoring the traffic in a particular channel associated with the physical connection.
